(19) United States
(12) Patent Application Publication
(10) Pub. No.: US 2019/0178698 A1
(43) Pub. Date: Jun. 13, 2019

(54) WIRELESS REMOTE SENSING OF CHANGES IN FLUID FILLED CONTAINERS

(71) Applicant: THE REGENTS OF THE UNIVERSITY OF CALIFORNIA, Oakland, CA (US)

(72) Inventors: Dieter R. Enzmann, Beverly Hills, CA (US); William J. Kaiser, Los Angeles, CA (US); Jay M. Lee, Los Angeles, CA (US)

(73) Assignee: THE REGENTS OF THE UNIVERSITY OF CALIFORNIA, Oakland, CA (US)

(21) Appl. No.: 16/205,415

(22) Filed: Nov. 30, 2018

Related U.S. Application Data
(63) Continuation of application No. PCT/US2017/035421, filed on Jun. 1, 2017.
(60) Provisional application No. 62/345,122, filed on Jun. 3, 2016.

(51) Int. Cl. G01F 23/26; G01F 23/24; G01F 23/14; G01F 9/00

(52) U.S. Cl. CPC G01F 23/263; G01F 23/242; G01F 9/001; G01F 23/246; G01F 23/14

(57) ABSTRACT

A wireless remote monitoring system for biomedical fluid management that uses one or more sensors to detect changes in fluid or air in any container attached to a patient in order to monitor pre-surgical or post-surgical progress or complications. The sensors may be configured to monitor any type of container used to collect fluid or air from the human body, to transmit the sensor signals wirelessly to any number of devices including, but not limited to, cell phones or devices which in turn can send data to a functional repository where it can be analyzed and potentially acted upon by either a central or distributed network of providers.

### CROSS-REFERENCE TO RELATED APPLICATIONS

This application claims priority to, and is a 35 U.S.C. § 111(a) continuation of, PCT international application number PCT/US2017/035421 filed on Jun. 1, 2017, incorporated herein by reference in its entirety, which claims priority to, and the benefit of, U.S. provisional patent application Ser. No. 62/345,122 filed on Jun. 3, 2016, incorporated herein by reference in its entirety. Priority is claimed to each of the foregoing applications.

The above-referenced PCT international application was published as PCT International Publication No. WO 2017/210414 A1 on Dec. 7, 2017, which publication is incorporated herein by reference in its entirety.

### STATEMENT REGARDING FEDERALLY SPONSORED RESEARCH OR DEVELOPMENT

Not Applicable

### NOTICE OF MATERIAL SUBJECT TO COPYRIGHT PROTECTION

A portion of the material in this patent document may be subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND

### 1. Technical Field

The technology of this disclosure pertains generally to sensing systems, and more particularly to remote sensing to changes in fluid filled containers.

### 2. Background Discussion

Fluid management is a critical aspect of patient care, particularly for elderly patients and patients pre- and post-surgery. The UK's Care Quality Commission has described fluid management at many hospitals as “appalling”, with over 1,100 patient deaths in the past ten years due to poor fluid management. Hospitals attribute this poor care due to issues such as inadequate staffing, lack of time, and lack of training. Since fluid management is sensitive and time-intensive, a major challenge is the difficulty to monitor every patient's fluids to a sufficient level of attention with a finite staff. Trials of remote sensing of patient metrics, such as blood pressure, have been successful in reducing hospital visits and medical costs by increasing accuracy and amount of data, while lowering amount of staff time necessary to take the data. However, for accurate fluid management, staff must measure and analyze the fluids, their flow rates, and their compositions in order to ensure quality care.

Accordingly, an object of the present technology is a system and method to remotely monitor these metrics to reduce the costs, complications, and deaths related to fluid management.

### BRIEF SUMMARY

An aspect of the present technology is a device and methods for continuous and dynamic monitoring of patient fluids, which can monitor and quantify patient conditions. This technology can be used to quickly detect discrepancies which may be signs of complications before or after surgery. The data collected can be viewed or analyzed on a number of devices, including computers or mobile devices, and would decrease the necessary time for staff to attend patients and measure the necessary data.

One embodiment includes a wireless remote monitoring system for biomedical fluid management that addresses the urgent, unmet need for reliable, assured, low cost, compact, monitoring by providing one or more of the following functions: 1) air leak detection; 2) fluid accumulation rate; 3) fluid accumulation total; 4) fluid composition indication; and 5) tube blockage detection, etc.

In one aspect of technology described herein, the system uses one or more sensors to detect changes in fluid or air in any container attached to a patient in order to monitor pre-surgical or post-surgical progress or complications. The sensors may be configured to monitor any type of container used to collect fluid or air from the human body, to transmit the sensor signals wirelessly to any number of devices including, but not limited to, cell phones or dedicated Bluetooth or LAN devices which in turn can send data to a functional repository where it can be analyzed and potentially acted upon by either a central or distributed network of providers.

In preferred embodiments, the sensors are configured to detect one or more of the presence of fluid, its volume, its inflow, its outflow, and other dynamic features. The sensors may also be configured to analyze the fluid in terms of temperature, density, viscosity, vesicular matter, cell content, hemoglobin content, and any additional chemical, cellular or biological material of interest.

The technology described herein includes wireless sensor technology for monitoring continuously and in dynamic fashion, pre- and post-surgical patients who have some type of connected container for collecting some type bodily fluid. This is a major facilitator of reducing hospital stays, reducing costs, and reducing surgical complications.

In a preferred embodiment, the materials selected for the components of the present technology are those matching standard products meeting requirements for biocompatibility and cleaning and disinfection requirements and that are proven effective and safe, without introducing new materials that are in contact with the subject or with fluids or any part of the fluid management reservoir volume.

Further aspects of the technology described herein will be brought out in the following portions of the specification, wherein the detailed description is for the purpose of fully disclosing preferred embodiments of the technology without placing limitations thereon.

### BRIEF DESCRIPTION OF THE SEVERAL VIEWS OF THE DRAWING(S)

The technology described herein will be more fully understood by reference to the following drawings which are for illustrative purposes only:

FIG. 1 is schematic diagram of a fluid-holding container comprising the wireless remote monitoring system of the present description.

FIG. 2 is a top section view of the container of FIG. 1.

FIG. 3 is a system schematic view of the wireless sensor system of the present description with an external wireless device.

### DETAILED DESCRIPTION

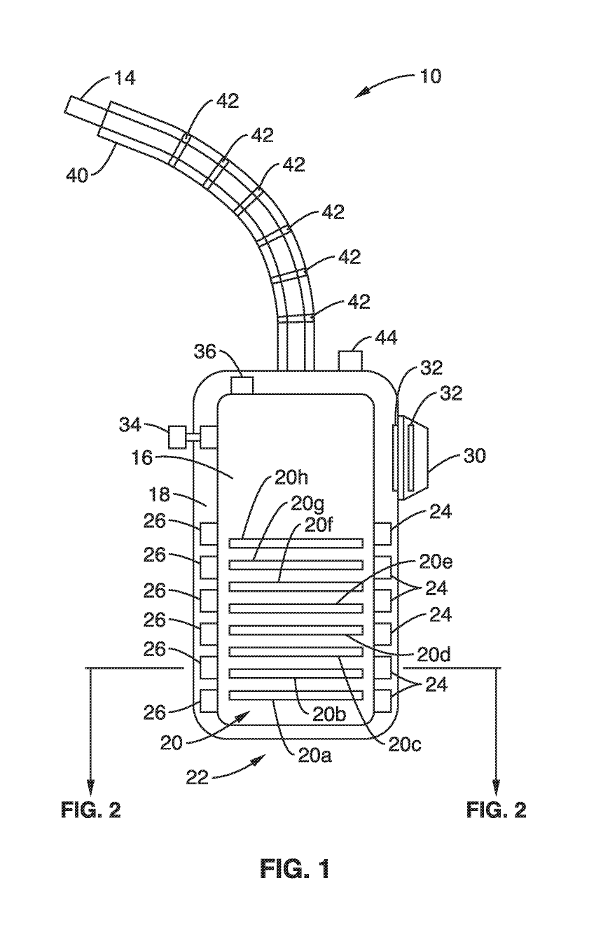

FIG. 1 shows a schematic diagram of a fluid-holding container 12 comprising the wireless remote monitoring system 10 of the present description. Wireless remote monitoring system 10 is shown in FIG. 1 with a number of sensing modalities, such as 1) air leak detection; 2) fluid accumulation rate; 3) fluid accumulation total; 4) fluid composition indication; and 5) tube blockage detection, etc. It is appreciated that the sensing modalities are not limited to those shown in FIG. 1, and that the wireless remote monitoring system 10 may include a subset of the sensing modalities shown (e.g., one embodiment may comprise only the fluid accumulation sensors). In the embodiment shown in FIG. 1, the wireless remote monitoring system 10 is shown integrated with the container 12 (e.g. sensors are disposed within container walls 18). However, it is appreciated that the wireless remote monitoring system 10 may comprise a completely independent device that may be attached to the container 12, e.g. as a patch or releasable layer that may adhesively or otherwise attach to one or more surfaces (external or internal) of the container 12 or feeding/delivery tube 14.

Each of the primary sensing modalities of the wireless remote monitoring system 10 will be discussed individually in greater detail below.

1. Capacitive Monitoring of Fluid Level and Accumulation Rate

In the wireless remote monitoring system 10, monitoring of total fluid accumulation or fluid level is preferably achieved through capacitive monitoring via two arrays 20 and 22 of electrodes that are disposed on opposite sides of the fluid reservoir 16 of the container 12. The electrode arrays 20, 22 are configured to exploit a physical property known as capacitance to determine the existence of liquid in the space between the electrodes.

In its simplest form, a capacitor is embodied as two conductive plates separated by an electrical insulator. If a voltage is applied to one of the plates, charge accumulates on that plate, and an equal and opposite charge accumulates on the opposite plate. The amount of charge that accumulates in response to a unit change in applied voltage is governed by the capacitance, C, given by:

$$C = ɛ \frac{A}{d} , \qquad Eq . 1$$

where A is the area of the plates, d is the distance between the two plates, and ε represents the dielectric constant, a physical property of the material (fluid) in the space between the plates.

In the remote monitoring system 10, electrode area and separation distance remain constant (so long as their attachment remains stable and the container 12 does not flex), so any change in measured capacitance is caused by a change in the makeup of the material between the plates. Thus, measurement of the capacitance between the two plates or electrodes can provide information regarding the volume between the plates. For example, the dielectric constant of fluids that may accumulate in the reservoir have an elevated dielectric constant relative to air, so accumulation of such fluid would increase the capacitance observed between two electrodes as the fluid level rises into the space between them.

By integrating a pair of electrode arrays 20, 22 on opposite sides of the reservoir 16, and measuring the capacitance between them, fluid level in the reservoir can be accurately measured in an entirely non-invasive manner that introduces no new materials or objects into the reservoir volume.

FIG. 1 shows one side of container 12, with an array 20 of horizontally-oriented, elongate dielectric electrodes 20a through 20h disposed in a parallel fashion from the bottom of the reservoir 16. The electrodes are preferably placed at increments corresponding to a desired fluid measurement. For example, each electrode 20a through 20h may be at a vertical position on the container 12 such that when fluid is detected at that electrode, a specific fluid volume is identified. Each spaced apart increment between the vertically disposed electrodes may correspond to a volume of fluid based on the reservoir 16 cross-section (e.g. in cc's, milliliters etc.). For example, a positive reading of fluid by electrode 20a (and corresponding paired electrode 22a opposite the container) indicates a reading for the smallest possible volume increment in the container (e.g. 25 mL). If no other electrodes in the array have a positive fluid measurement, than the total fluid volume in the container 12 is that increment (e.g. 25 mL). If electrode 20h shows a positive fluid measurement, than the total fluid in the container would be 8× the increment (e.g. 200 mL). Measurements made over time may also be used to calculate the fluid accumulation rate within the reservoir 16. It is appreciated that any number of electrodes may be disposed in varying increments on or in the container walls 18.

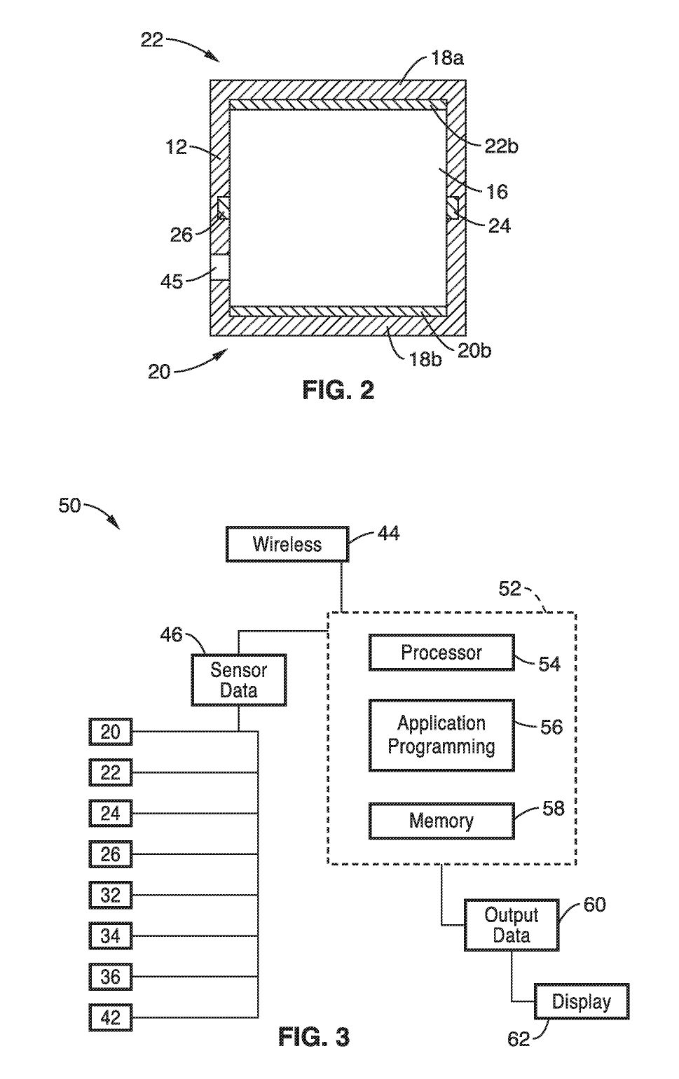

FIG. 2 shows a cross-section view of the container 12 at about the second electrode up from the bottom of the reservoir 16. Electrode 20b from array 20 is disposed on wall 18b, with corresponding electrode 22b from array 20 being disposed opposite the reservoir 16. The electrodes 20b and 22b are shown in FIG. 2 on the inside surface of the reservoir. However, it is appreciated that electrodes 20b and 22b may also be positioned within or on an external surface of walls 18a, 18b. In one configuration, the electrode arrays 20 and 22 are disposed within a sleeve or laminate (not shown) surrounding the container 12.

It is appreciated that measurement of capacitance can be implemented using small, low-cost components. Further, while the orientation of the reservoir can impact the extent to which fluid occurs between pairs of electrodes, an accelerometer 45 (FIG. 2) may be integrated into the device at the reservoir wall to measure the angle of the reservoir 16 relative to gravity/vertical, and thus enable compensation for this angle in determination of reservoir filling level. This allows for accurate computation of fluid volume independent of reservoir orientation. The system 10 may further include optional gyroscope micro-sensor systems (not shown) for detection of motion and orientation to enable detection of events that may compromise operation of the chest tube drainage process.

As described above, capacitance can be thought of as the amount of charge that accumulates on an electrode in response to application of a voltage to that electrode. While capacitance may be measured using this principle, other methods are also available. One such method is to apply a sinusoidal voltage to the capacitor through a known resistance. The resistor and capacitor form a circuit known as an RC circuit wherein the phase and amplitude of the signal arriving at the capacitor relative to that applied to the resistor can be used to compute capacitance.

For an idealized capacitor, the computed capacitance would remain constant across all input frequencies. However, this assumption of an idealized capacitor depends on a perfect dielectric between plates. In practice, as input frequency increases, measured capacitance can undergo changes based on the properties of this dielectric. This property, known as frequency dispersion, provides a probe into the dielectric properties of the fluid or air in the reservoir. Thus, characteristics such as salinity and pH may be modeled based on this approach using the dielectric electrode arrays 20, 22.

2. Monitoring of Fluid Composition

In one embodiment, the remote monitoring system 10 comprises sensors for multispectral LED and photodiode transmittance. In the system shown in FIG. 1, an array of light sources (e.g. Light Emitting Diodes (LED's)) 24 are coupled to one side of the container 12, and a set of optical detectors (e.g. photodiodes and/or photoresistors) 26 is coupled to or integrated onto the opposite side of the container 12 from reservoir 16 (see also FIG. 2 showing LED 24 and optical detector 26 embedded in opposite walls of the container 12). Photodiodes are semiconductor devices that generate current when exposed to light, whereas photoresistors undergo a change in electrical resistance in response to light. Either may be incorporated where appropriate for a given application. While the LED 24 and optical detector 26 are shown disposed within container walls in FIG. 2, it is appreciated that the LED 24 and optical detector 26 arrays may be disposed within a sleeve or laminate (not shown) surrounding a translucent container 12.

By transmitting light from the LEDs 24 in a controlled manner and measuring the response in the optical detectors 26 on the opposite side, optical characteristics of the reservoir 16 can be quantified. For example, if red light is transmitted through the reservoir efficiently, resulting in significant change in output by the corresponding photo detector devices 26, but blue and green light is absorbed, resulting in minimal change in the photo detector devices, then it can be determined that the fluid in the reservoir is red in color. This approach, known as absorbance spectrophotometry, may be used further characterize fluid in the reservoir in an entirely non-invasive manner. For example, the sensors may be configured to sense blood in the reservoir. The LEDs 24 and corresponding photo detector devices 26 may also be used to characterize fluid accumulation if disposed in an incremented vertical fashion similar to the dielectric electrodes 20, 22.

Fluid characterization may be configured to monitor changes in blood, pH, enzymes, inflammatory/infection markers, metabolites, and other characteristics.

Recent advances in LEDs have enabled controlled emission of light with a wide variety of spectral characteristics. LED's 24 may be implemented as small, low-cost LED Red-Green-Blue (RGB) packages on or within container 12 walls 18. These devices may be configured to emit a controlled combination of RGB light, or infrared light depending on the application.

Shielding (not shown) may also be included to prevent interference resulting from external contact or signal sources.

3. Flow Sensing for Tubular Blockage.

Flow of fluid travelling into the container 12 via tube 14 may also be measured. In one embodiment, a sleeve 40 is disposed around tube 14, the sleeve containing a plurality of spaced apart thermal flow sensors 42 used to non-invasively measure the flow of liquid or gas through the tube 14.

In one embodiment, the amount of heat transferred from a heating element 42 into the gas or liquid is used to estimate the flow rate. If the gas or liquid is flowing at a high rate, the heating element constantly encounters new, unheated material, and thereby delivers a relatively large amount of heat into it. Thus, the amount of energy provided to the heating element increases. This quantity can be readily measured and yields a measure of the flow in the tube 14. Alternatively, if there is little or no flow in the tube, the material in contact with the heating element 42 remains stagnant and rapidly achieves thermal equilibrium. This reduces the amount of thermal transfer from the heating element 42, thereby reducing the amount of power applied to the element. This quantity then indicates a reduced rate of flow through the tube.

One of the primary advantages of this sensing modality is that it can be implemented entirely external to the system being monitored. The heating element 42 can be applied external to the tube 14, and the systems used to heat the element and measure power dissipation are also external to the tube 14. Further, the heating element 42 does not need to be heated to a particularly high temperature, ensuring safe operation. Thus, this sensing modality is ideal for monitoring the flow of fluid through device tabulation into the reservoir 16. No new materials are introduced into the reservoir 16, and user safety is not compromised.

Tube blockage and fluid accumulation events may also be monitored by the using an array of dielectric property, capacitance-sensing electrodes (similar to electrode arrays 20, 22, but disposed at the locations of the heating elements 42) within the sleeve 40 and external to the tube material 14. Shielding (that may be transparent and conductive) may also be employed to prevent interference resulting from external contact or signal sources.

4. Gas Pressure Monitoring/Air Leak Detection

In one embodiment, the remote monitoring system 10 is coupled to a chest drain reservoir, and comprises an air pressure indicator (which may be in the form of an absolute pressure sensor 36 or differential pressure sensor 34) that is used to optically indicate loss of the preferred weak-vacuum state in which reservoirs are desirably maintained. In one such embodiment, in the case of a change in air pressure, a colored indicator (not shown) that is typically held in place by the vacuum is released and becomes flush against the inside of the reservoir. This indicator subsequently becomes visible through the translucent reservoir 16, indicating a loss of desired air pressure.

This configuration may integrate LED emitter/receiver pairs (such as LED 24 and photodiode 26) to monitor the state of such indicators, thereby provided vigilant monitoring of reservoir pressure conditions. As such, there is no need for monitoring by the patient or clinical staff.

In a further embodiment, the remote monitoring system 10 may comprise one or more air leak detection sensors at valve 30. For example, a pair of dielectric electrode plates 32 may be disposed on opposing sides of the valve 30 seat for capacitive sensing of the valve seal via methods similar to those disclosed for the capacitive sensing of electrode pairs 20, 22.

5. Sensor Fusion and Classification Systems

FIG. 3 shows a schematic system view of a wireless sensor system 50 coupled with an external wireless device in accordance with the present description. The remote monitoring system 10 may include wireless communication circuitry for receiving sensor data 46 from the various sensors (e.g. one or more of sensors 20, 22, 24, 26, 32, 34, 36, 42 and 45) and transmitting the sensor data 46 to an external computing device 52 (e.g. computer, smart phone, or like device). Application programming 56 may be stored in memory 58, and executable on processor 54 for analyzing sensor data 46 to output fluid characteristics of the system 10 in the form of output data 60.

In one embodiment, application programming 56 may include routines for machine learning methods applied to generate reliable classification of system state. For example, the system 10 gathers sensor data 46 associated with one or more of reservoir 16 orientation, optical characteristics of reservoir fluids, capacitive coupling and frequency dispersion in the reservoir, flow of liquid through tabulation into the reservoir 16, gas pressure, and gas flow. There may be several instances of each sensor in use. Thus, the number of sensor inputs (e.g. from one or more of sensors 20, 22, 24, 26, 32, 34, 36, 42 and 45) may grow quite large, and a traditional classification system based on hard thresholds may grow intractable. However, advanced machine learning techniques, such as Neural Networks and Support Vector Machines offer high-performance sensor fusion capabilities applicable to this system. In a preferred embodiment, all data streams will serve as inputs into a classifier, which would inform a decision based on system state. Further, the set of classified states might include, for example, normal, elevated concern, and critical concern. Thus, the large volume of data from the reservoir monitor can be used to guide patient care through advanced sensor fusion techniques.

The system 10 may also include the capability for providing notification of conditions associated with the one or more sensors (e.g. one or more of sensors 20, 22, 24, 26, 32, 34, 36, 42 and 45), such as air leak, fluid accumulation rate and accumulation total, blockage, orientation, and motion.

In one embodiment, the application programming 56 may be configured to provide status and event notifications. This includes:

a. Local display: A local display 62 integrated in the system 10 (or use display of device 52) to indicate status and events.

b. Local wireless or wired display: Display 62 may be in the form of a compact display unit may also be included with the system 10 for display of status. This compact display unit may include a wireless tablet device.

c. Remote monitoring: System sensor data 46 may be transported over wireless and Internet data transport to remote systems 52 that provide Web-based access, messaging and alert systems, and also include constantly vigilant services that ensure device access and operation.

In one embodiment, the wireless communications circuit 44 may be configured as one or more NFC tags that are compatible with the Near Field Communications (NFC) platform to achieve low cost data transmission and logging. Remote processing device 52 may comprise an NFC enabled smart phone 52 that serves as the NFC reader, which automatically receives data from in range NFC tags. The NFC tags may be configured to harvest energy from the smart phone 52.

The system 10 may also include a battery pack system (not shown) or other wireless inductively coupled energy recharge, enabling multiday operation.

Also, one embodiment of the remote monitoring system 10 may be integrated with a container system (e.g. embedded sensors within container walls 18), as provided by vendors, that is generally a polymer system with polymer standard tubing, both of which have proven sterility and safety. Add-on remote monitoring system 10 configurations may be added to an existing container 12 or tube 14 (at the time of manufacture or in the field, e.g. via adhesive or other attachment means), and do not degrade this sterility since they are external. In one embodiment, the components of the remote monitoring system 10 may be in the form of a smart clip or smart tape for attaching to the container 12.

In some embodiments, sterile electrochemical sensors may be use on inside surface, while other circuitry 44 and external interrogator device 52 are disposed outside.

While the embodiments detailed above are illustrated primarily for medical uses, such as systems and methods disclosed herein may be used for a variety of applications where remote sensing is desired.

Embodiments of the present technology may be described herein with reference to flowchart illustrations of methods and systems according to embodiments of the technology, and/or procedures, algorithms, steps, operations, formulae, or other computational depictions, which may also be implemented as computer program products. In this regard, each block or step of a flowchart, and combinations of blocks (and/or steps) in a flowchart, as well as any procedure, algorithm, step, operation, formula, or computational depiction can be implemented by various means, such as hardware, firmware, and/or software including one or more computer program instructions embodied in computer-readable program code. As will be appreciated, any such computer program instructions may be executed by one or more computer processors, including without limitation a general purpose computer or special purpose computer, or other programmable processing apparatus to produce a machine, such that the computer program instructions which execute on the computer processor(s) or other programmable processing apparatus create means for implementing the function(s) specified.

Accordingly, blocks of the flowcharts, and procedures, algorithms, steps, operations, formulae, or computational depictions described herein support combinations of means for performing the specified function(s), combinations of steps for performing the specified function(s), and computer program instructions, such as embodied in computer-readable program code logic means, for performing the specified function(s). It will also be understood that each block of the flowchart illustrations, as well as any procedures, algorithms, steps, operations, formulae, or computational depictions and combinations thereof described herein, can be implemented by special purpose hardware-based computer systems which perform the specified function(s) or step(s), or combinations of special purpose hardware and computer-readable program code.

Furthermore, these computer program instructions, such as embodied in computer-readable program code, may also be stored in one or more computer-readable memory or memory devices that can direct a computer processor or other programmable processing apparatus to function in a particular manner, such that the instructions stored in the computer-readable memory or memory devices produce an article of manufacture including instruction means which implement the function specified in the block(s) of the flowchart(s). The computer program instructions may also be executed by a computer processor or other programmable processing apparatus to cause a series of operational steps to be performed on the computer processor or other programmable processing apparatus to produce a computer-implemented process such that the instructions which execute on the computer processor or other programmable processing apparatus provide steps for implementing the functions specified in the block(s) of the flowchart(s), procedure (s) algorithm(s), step(s), operation(s), formula(e), or computational depiction(s).

It will further be appreciated that the terms “programming” or “program executable” as used herein refer to one or more instructions that can be executed by one or more computer processors to perform one or more functions as described herein. The instructions can be embodied in software, in firmware, or in a combination of software and firmware. The instructions can be stored local to the device in non-transitory media, or can be stored remotely such as on a server, or all or a portion of the instructions can be stored locally and remotely. Instructions stored remotely can be downloaded (pushed) to the device by user initiation, or automatically based on one or more factors.

It will further be appreciated that as used herein, that the terms processor, hardware processor, computer processor, central processing unit (CPU), and computer are used synonymously to denote a device capable of executing the instructions and communicating with input/output interfaces and/or peripheral devices, and that the terms processor, hardware processor, computer processor, CPU, and computer are intended to encompass single or multiple devices, single core and multicore devices, and variations thereof.

From the description herein, it will be appreciated that that the present disclosure encompasses multiple embodiments which include, but are not limited to, the following:

1. An apparatus for detecting changes in fluid or air in a container, the apparatus comprising: a plurality of sensors configured to be attached to a container of a type used to collect fluid or air from a human body; said sensors configured to monitor changes in fluid or air in the container; and a wireless communications interface configured for receiving data from the plurality of sensors and sending the data to a remote processor configured to analyze the data.

2. The apparatus of any preceding embodiment: wherein the plurality of sensors comprise first and second arrays of paired sensors; wherein a first array is disposed on a first side of the container and a second array is disposed on a second side of the container opposite a reservoir disposed between the first side and second side; and wherein each sensor in the first array is paired with a corresponding sensor in the second array to form a sensor pair configured to measure a characteristic of a fluid or air within the reservoir.

3. The apparatus of any preceding embodiment, wherein the sensor pairs are disposed at incremental elevation locations within the reservoir such that the sensors detect the fluid or air characteristic at the incremental elevation locations.

4. The apparatus of any preceding embodiment, wherein the incremental elevation locations corresponding to a volume increment to indicate a volume of a liquid within the reservoir.

5. The apparatus of any preceding embodiment, wherein the at least two electrode pairs are configured to simultaneously acquire sensor data to measure a fluid flow rate within the container.

6. The apparatus of any preceding embodiment, wherein the sensor pairs comprise dielectric electrodes configured to measure capacitance within the reservoir.

7. The apparatus of any preceding embodiment: wherein the sensor pairs comprise an LED disposed on the first side of the container, and a photo-detector on the second side of the container; and wherein the sensor pairs are configured to determine the composition of the fluid or air inside the reservoir.

8. The apparatus of any preceding embodiment, further comprising: a tube coupled to the reservoir; wherein the plurality of sensors comprise one or more sensors disposed at spaced apart locations on said tube to measure flow rate of a fluid in the tube for delivery to or from the container.

9. The apparatus of any preceding embodiment, wherein the plurality of sensors are disposed within a sleeve surrounding an external surface of the tube.

10. The apparatus of any preceding embodiment, wherein the plurality of sensors comprise thermal sensors configured to measure dissipation of heat within the fluid; said heat dissipation relating to the flow rate of the fluid.

11. The apparatus of any preceding embodiment, wherein the plurality of sensors are configured to analyze said fluid for one or more characteristics selected from the group consisting of temperature, density, viscosity, vesicular matter, cell content, hemoglobin content, and any additional chemical, cellular or biological material of interest.

12. The apparatus of any preceding embodiment, wherein the plurality of sensors comprise a pressure sensor configured to detect a leak within the sensor.

13. The apparatus of any preceding embodiment, wherein the container comprises a valve having a valve seat; wherein the plurality of sensors comprise a pair of dielectric electrodes disposed on opposing sides of the valve seat to measure capacitance across the valve seat.

14. The apparatus of any preceding embodiment, further comprising: a tri-axial accelerometer coupled to the reservoir wall to measure angle of the reservoir with respect to vertical and thus enable compensation for reservoir orientation in determination of the volume of liquid within the reservoir.

15. The apparatus of any preceding embodiment, wherein the plurality of sensors are disposed within a sleeve surrounding an external surface of the reservoir.

16. A system for detecting changes in fluid or air in a container, the apparatus comprising: a plurality of sensors configured to be attached to a container of a type used to collect fluid or air from a human body; said sensors configured to monitor changes in fluid or air in the container; and a wireless communications interface configured for receiving data from the plurality of sensors and sending the data to a remote computing device; said remote computing device comprising: a processor; a non-transitory memory storing instructions executable by the processor; wherein said instructions, when executed by the processor, are configured to analyze the data from the plurality of sensors to measure a characteristic of a fluid or air within the reservoir.

17. The system of any preceding embodiment: wherein the plurality of sensors comprise first and second arrays of paired sensors; wherein a first array is disposed on a first side of the container and a second array is disposed on a second side of the container opposite a reservoir disposed between the first side and second side; and wherein each sensor in the first array is paired with a corresponding sensor in the second array to form a sensor pair configured to measure the characteristic of a fluid or air within the reservoir.

18. The system of any preceding embodiment, wherein the sensor pairs are disposed at incremental elevation locations within the reservoir such that the sensors detect the fluid or air characteristic at the incremental elevation locations.

19. The system of any preceding embodiment, wherein the incremental elevation locations corresponding to a volume increment to indicate a volume of a liquid within the reservoir.

20. The system of any preceding embodiment, wherein the at least two electrode pairs are configured to simultaneously acquire sensor data to measure a fluid flow rate within the container.

21. The system of any preceding embodiment, wherein the sensor pairs comprise dielectric electrodes configured to measure capacitance within the reservoir.

22. The system of any preceding embodiment: wherein the sensor pairs comprise an LED disposed on the first side of the container, and a photo-detector on the second side of the container; and wherein the sensor pairs are configured to determine the composition of the fluid or air inside the reservoir.

23. The system of any preceding embodiment, further comprising: a tube coupled to the reservoir; wherein the plurality of sensors comprise one or more sensors disposed at spaced apart locations on said tube to measure flow rate of a fluid in the tube for delivery to or from the container.

24. The system of any preceding embodiment, wherein the plurality of sensors are disposed within a sleeve surrounding an external surface of the tube.

25. The system of any preceding embodiment, wherein the plurality of sensors comprise thermal sensors configured to measure dissipation of heat within the fluid; said heat dissipation relating to the flow rate of the fluid.

26. The system of any preceding embodiment, wherein the plurality of sensors comprise a pressure sensor configured to detect a leak within the sensor.

27. The system of any preceding embodiment, wherein the container comprises a valve having a valve seat; wherein the plurality of sensors comprise a pair of dielectric electrodes disposed on opposing sides of the valve seat to measure capacitance across the valve seat.

28. The system of any preceding embodiment, further comprising: a tri-axial accelerometer coupled to the reservoir wall to measure angle of the reservoir with respect to vertical and thus enable compensation for reservoir orientation in determination of the volume of liquid within the reservoir.

29. The system of any preceding embodiment, wherein the plurality of sensors are disposed within a sleeve surrounding an external surface of the reservoir.

30. An apparatus for detecting changes in fluid or air in a container, the apparatus comprising: a plurality of sensors configured to be attached to a container of a type used to collect fluid or air from a human body; said sensors configured to monitor changes in fluid or air in the container; and a wireless communications interface configured for receiving data from one or more of the sensors and sending the data to a remote processor configured to analyze the data.

31. The apparatus of any preceding embodiment, wherein the sensors are configured to sense one or more characteristics of the container selected from the group consisting of: the presence of fluid in container, volume of fluid in the container, container inflow, container outflow, and other dynamic features.

32. The apparatus of any preceding embodiment, wherein the sensors are configured to analyze said fluid for one or more characteristics selected from the group consisting of: temperature, density, viscosity, vesicular matter, cell content, hemoglobin content, and any additional chemical, cellular or biological material of interest.

33. The apparatus of any preceding embodiment, wherein the apparatus is configured to monitor continuously and in dynamic fashion, pre- and post-surgical patients who have some type of connected container for collecting some type bodily fluid.

Although the description herein contains many details, these should not be construed as limiting the scope of the disclosure but as merely providing illustrations of some of the presently preferred embodiments. Therefore, it will be appreciated that the scope of the disclosure fully encompasses other embodiments which may become obvious to those skilled in the art.

In the claims, reference to an element in the singular is not intended to mean “one and only one” unless explicitly so stated, but rather “one or more.” All structural, chemical, and functional equivalents to the elements of the disclosed embodiments that are known to those of ordinary skill in the art are expressly incorporated herein by reference and are intended to be encompassed by the present claims. Furthermore, no element, component, or method step in the present disclosure is intended to be dedicated to the public regardless of whether the element, component, or method step is explicitly recited in the claims. No claim element herein is to be construed as a “means plus function” element unless the element is expressly recited using the phrase “means for”. No claim element herein is to be construed as a “step plus function” element unless the element is expressly recited using the phrase “step for”.

What is claimed is:

1. An apparatus for detecting changes in fluid or air in a container, the apparatus comprising:
a plurality of sensors configured to be attached to a container of a type used to collect fluid or air from a human body;
said sensors configured to monitor changes in fluid or air in the container; and
a wireless communications interface configured for receiving data from the plurality of sensors and sending the data to a remote processor configured to analyze the data.

2. The apparatus of claim 1:
wherein the plurality of sensors comprise first and second arrays of paired sensors;
wherein a first array is disposed on a first side of the container and a second array is disposed on a second side of the container opposite a reservoir disposed between the first side and second side; and
wherein each sensor in the first array is paired with a corresponding sensor in the second array to form a sensor pair configured to measure a characteristic of a fluid or air within the reservoir.

3. The apparatus of claim 2, wherein the sensor pairs are disposed at incremental elevation locations within the reservoir such that the sensors detect the fluid or air characteristic at the incremental elevation locations.

4. The apparatus of claim 3, wherein the incremental elevation locations corresponding to a volume increment to indicate a volume of a liquid within the reservoir.

5. The apparatus of claim 4, wherein the at least two electrode pairs are configured to simultaneously acquire sensor data to measure a fluid flow rate within the container.

6. The apparatus of claim 3, wherein the sensor pairs comprise dielectric electrodes configured to measure capacitance within the reservoir.

7. The apparatus of claim 3:
wherein the sensor pairs comprise an LED disposed on the first side of the container, and a photo-detector on the second side of the container; and
wherein the sensor pairs are configured to determine the composition of the fluid or air inside the reservoir.

8. The apparatus of claim 1, further comprising:
a tube coupled to the reservoir;
wherein the plurality of sensors comprise one or more sensors disposed at spaced apart locations on said tube to measure flow rate of a fluid in the tube for delivery to or from the container.

9. The apparatus of claim 8, wherein the plurality of sensors are disposed within a sleeve surrounding an external surface of the tube.

10. The apparatus of claim 8, wherein the plurality of sensors comprise thermal sensors configured to measure dissipation of heat within the fluid;
said heat dissipation relating to the flow rate of the fluid.

11. The apparatus of claim 1, wherein the plurality of sensors are configured to analyze said fluid for one or more characteristics selected from the group consisting of temperature, density, viscosity, vesicular matter, cell content, hemoglobin content, and any additional chemical, cellular or biological material of interest.

12. The apparatus of claim 1, wherein the plurality of sensors comprise a pressure sensor configured to detect a leak within the sensor.

13. The apparatus of claim 1, wherein the container comprises a valve having a valve seat;
wherein the plurality of sensors comprise a pair of dielectric electrodes disposed on opposing sides of the valve seat to measure capacitance across the valve seat.

14. The apparatus of claim 1, further comprising:
a tri-axial accelerometer coupled to the reservoir wall to measure angle of the reservoir with respect to vertical and thus enable compensation for reservoir orientation in determination of the volume of liquid within the reservoir.

15. The apparatus of claim 1, wherein the plurality of sensors are disposed within a sleeve surrounding an external surface of the reservoir.

16. A system for detecting changes in fluid or air in a container, the apparatus comprising:
a plurality of sensors configured to be attached to a container of a type used to collect fluid or air from a human body;
said sensors configured to monitor changes in fluid or air in the container; and
a wireless communications interface configured for receiving data from the plurality of sensors and sending the data to a remote computing device;
said remote computing device comprising:
a processor; and
a non-transitory memory storing instructions executable by the processor;
wherein said instructions, when executed by the processor, are configured to analyze the data from the plurality of sensors to measure a characteristic of a fluid or air within the reservoir.

17. The system of claim 16:
wherein the plurality of sensors comprise first and second arrays of paired sensors;
wherein a first array is disposed on a first side of the container and a second array is disposed on a second side of the container opposite a reservoir disposed between the first side and second side; and
wherein each sensor in the first array is paired with a corresponding sensor in the second array to form a sensor pair configured to measure the characteristic of a fluid or air within the reservoir.

18. The system of claim 17, wherein the sensor pairs are disposed at incremental elevation locations within the reservoir such that the sensors detect the fluid or air characteristic at the incremental elevation locations.

19. The system of claim 18, wherein the incremental elevation locations corresponding to a volume increment to indicate a volume of a liquid within the reservoir.

20. The system of claim 19, wherein the at least two electrode pairs are configured to simultaneously acquire sensor data to measure a fluid flow rate within the container.

21. The system of claim 19, wherein the sensor pairs comprise dielectric electrodes configured to measure capacitance within the reservoir.

22. The system of claim 19:
wherein the sensor pairs comprise an LED disposed on the first side of the container, and a photo-detector on the second side of the container; and
wherein the sensor pairs are configured to determine the composition of the fluid or air inside the reservoir.

23. The system of claim 17, further comprising:
a tube coupled to the reservoir;
wherein the plurality of sensors comprise one or more sensors disposed at spaced apart locations on said tube to measure flow rate of a fluid in the tube for delivery to or from the container.

24. The system of claim 23, wherein the plurality of sensors are disposed within a sleeve surrounding an external surface of the tube.

25. The system of claim 23, wherein the plurality of sensors comprise thermal sensors configured to measure dissipation of heat within the fluid;
said heat dissipation relating to the flow rate of the fluid.

26. The system of claim 17, wherein the plurality of sensors comprise a pressure sensor configured to detect a leak within the sensor.

27. The system of claim 17, wherein the container comprises a valve having a valve seat;
wherein the plurality of sensors comprise a pair of dielectric electrodes disposed on opposing sides of the valve seat to measure capacitance across the valve seat.

28. The system of claim 17, further comprising:
a tri-axial accelerometer coupled to the reservoir wall to measure angle of the reservoir with respect to vertical and thus enable compensation for reservoir orientation in determination of the volume of liquid within the reservoir.

29. The system of claim 17, wherein the plurality of sensors are disposed within a sleeve surrounding an external surface of the reservoir.
